(19) United States
(12) Patent Application Publication
(10) Pub. No.: US 2016/0338541 A1
(43) Pub. Date: Nov. 24, 2016

(54) FOOD PREPARATION APPLIANCE

(71) Applicant: Spectrum Brands, Inc., Middleton, WI (US)

(72) Inventors: James Stuart Saunders, Madison, WI (US); Matthew James Hamilton, Madison, WI (US); Kroy Everett Nernberger, Madison, WI (US)

(21) Appl. No.: 15/157,736

(22) Filed: May 18, 2016

Related U.S. Application Data
(60) Provisional application No. 62/163,634, filed on May 19, 2015.

(51) Int. Cl. A47J 43/07

(52) U.S. Cl. CPC A47J 43/0711; A47J 2043/04427

(57) ABSTRACT

A food preparation appliance generally comprises a handle, a blade member operatively coupled to the handle and rotatable about a rotation axis. A first shroud is coaxial with the blade member and defines a blade chamber in which the blade member is at least in part disposed. A second shroud is coaxial with the first shroud. The first shroud has an upper side opening through which food processed by the blade member within the blade chamber of the first shroud may exit the blade chamber. The second shroud is positioned and configured relative to the first shroud such that food exiting the blade chamber through the upper side opening contacts the second shroud.

### CROSS REFERENCE TO RELATED APPLICATION

This application claims the benefit under 35 U.S.C. §119(e) of U.S. Provisional Patent Application No. 62/163,634, filed May 19, 2015 and titled “Food Preparation Appliance,” which is incorporated herein by reference in its entirety.

### FIELD

The field of the disclosure relates generally to food preparation appliances, and more particularly to hand-held food preparation appliances such as hand-held blenders and food processors that operate one or more blades to process food.

### BACKGROUND

Food preparation appliances such as blenders and food processors are commonly used to process foods, such as by chopping, crushing, cutting, liquefying, blending, mixing, etc. Some known blenders and food processors are designed to be held by a user during operation, i.e., they are hand-held. Such appliances typically have a handle and a drive motor that is drivingly connected to one or more blades. The motor rotates the one or more blades about an axis to process food. However, the food is not always evenly processed. Often times, for example, the food nearest the blades may be liquefied, whereas food located further from the blades remains intact (e.g., chunky).

The one or more blades of the appliance may also be shaped so as to impart both a rotational force and an axial force to the food during operation. For example, some blades are upwardly or downwardly angled to force the contents upward/downward as the blades strike the food, causing axial flow of the food. However, performance of the appliance can vary with the speed at which the blades are rotated. In some instances, for example, excessive blade rotation speeds may induce cavitation within the food being processed, generate too much suction, and/or propel food towards a user holding the appliance. Both cavitation within the food and too much suction in the appliance may cause non-uniformity in the final mixture and thus reduce the efficiency and usefulness of the appliance. If food is propelled towards the user, the user may be splashed and/or some food may be wasted, further decreasing the usefulness of the appliance.

Some known hand-held blenders and food processors have a generally inverted cup-shaped guard or shroud covering the blade. However, such a shroud can trap portions of the food between the shroud and the blade creating stagnant portions of processed food during use. As such, the stagnant portions are not well processed, and the final mixture may not have the desired consistency. Some shrouds have openings in the sidewall of the shroud to allow processed material to be forced away from the blades and out through the sidewall. However, in such a design some of the food being processed can be propelled toward the operator of the appliance as it exits the shroud openings. Additionally, the size of the openings can impact performance of the appliance. For example, small openings limit the amount of material that can be moved away from the blades and, therefore, inhibit the appliance from operating at a high speed, i.e., rotating the blades at a high speed to process new material continuously in a homogenous manner. However, large openings allow objects to enter into the blade chamber and contact the blades, thus increasing the risk of blade damage and increasing the risk of injury to the operator. Moreover, Underwriters Laboratory (UL) sets standards for the sizes of openings in such shrouds to ensure the appliance does not present an undue safety risk to operators. Therefore, the openings must be sized to meet UL standards in addition to meeting performance requirements.

As such, a need exists for a hand-held food preparation appliance that provides improved efficiency and uniformity of the processed contents while still meeting UL safety requirements.

### SUMMARY

In one aspect, a food preparation appliance generally comprises a handle, a blade that rotates about an axis, and a first shroud surrounding the blade. The first shroud defines an upper opening for transmitting food therethrough. The food preparation appliance further comprises a second shroud for redirecting food transmitted through the upper opening. The second shroud includes a handle surface facing the handle and a processing surface opposite the handle surface.

In one aspect a method for processing food using a food preparation appliance having a handle, a first shroud defining an interior, and a blade member rotatably driven within the interior during operation of the appliance is provided. The method generally comprises positioning the food preparation appliance such that the food is disposed within the interior. The blade member is rotated to contact the food and, thereby, propel the food towards the handle. The food is directed through an upper opening in the first shroud. The food is contacted with the second shroud and is redirected away from the handle after the food has passed through the opening.

In another aspect, a blade member for a food preparation appliance having a drive motor for operative connection with the blade member to drive rotation of the blade member about an axis of rotation is provided. The blade member is elongate and has a length. The blade member generally comprises a central planar portion extending substantially perpendicular to the axis of rotation of the blade member to lie in a first plane. The central planar portion has a first lengthwise end and a second lengthwise end opposite the first lengthwise end with the rotation axis of the blade member disposed therebetween. A first wing has a proximal end coupled to the first end of the central planar portion and a distal end disposed lengthwise outward of the proximal end of the first wing. A second wing has a proximal end coupled to the second lengthwise end of the central planar portion and a distal end disposed lengthwise outward of the proximal end of the second wing. At least a portion of the first wing lies in a second plane different from the first plane of the central planar portion.

### BRIEF DESCRIPTION OF THE DRAWINGS

FIG. 1 is a schematic side elevation of one embodiment of a food preparation appliance illustrated in the form of a hand-held blender.

FIG. 2 is a fragmented cross-section of the hand-held blender of FIG. 1 taken along line X-X of FIG. 1.

FIG. 3 is a bottom view of the hand-held blender of FIG. 1.

FIG. 4 is a perspective view of one embodiment of a blade member for use with the hand-held blender of FIG. 1.

FIG. 5 is a top plan view of the blade member of FIG. 4.

FIG. 6 is a front elevation of the blade member of FIG. 4.

FIG. 7 is a fragmented cross-section of the hand-held blender of FIG. 1 taken along line X-X of FIG. 1, the hand-held blender including a second embodiment of a blade member.

FIG. 8 is a bottom view of the hand-held blender of FIG. 7.

FIG. 9 is a perspective view of the blade member of FIG. 7.

FIG. 10 is a top plan view of the blade member of FIG. 7.

FIG. 11 is a front elevation of the blade member of FIG. 7.

### DETAILED DESCRIPTION OF THE INVENTION

Corresponding reference characters indicate corresponding parts throughout the several views of the drawings.

The present invention is directed generally to a food preparation appliance including at least one blade and at least two coaxially aligned shrouds—at least one of which defines a blade chamber for the at least one blade. The at least one blade rotates about an axis and is shaped to propel processed material upward. At least one of the shrouds redirects the processed material downward to provide a cyclic movement of the processed material. The cyclic movement improves efficiency of the food preparation appliance and uniformity of the processed food. Additionally, the two shrouds inhibit objects from entering the blade chamber and striking the at least one blade during operation. The two shrouds of the food preparation appliance satisfy Underwriters Laboratories (UL) standards while facilitating increased performance characteristics.

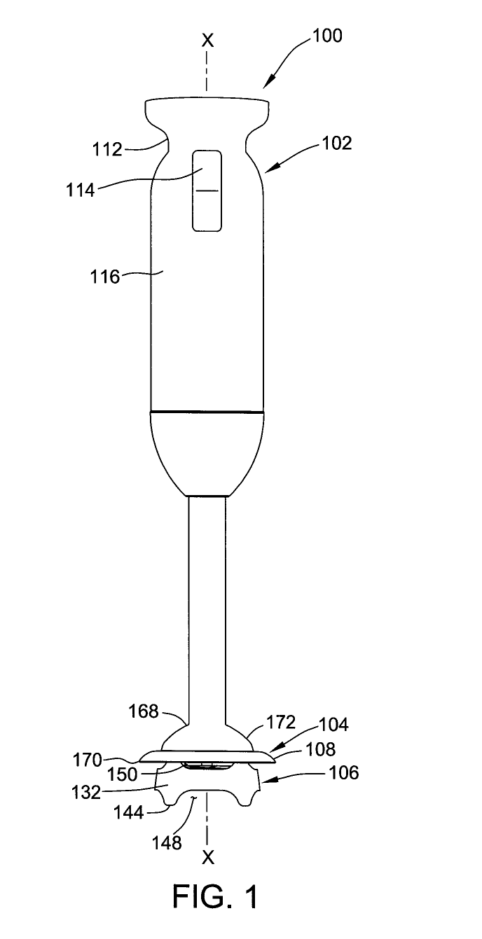

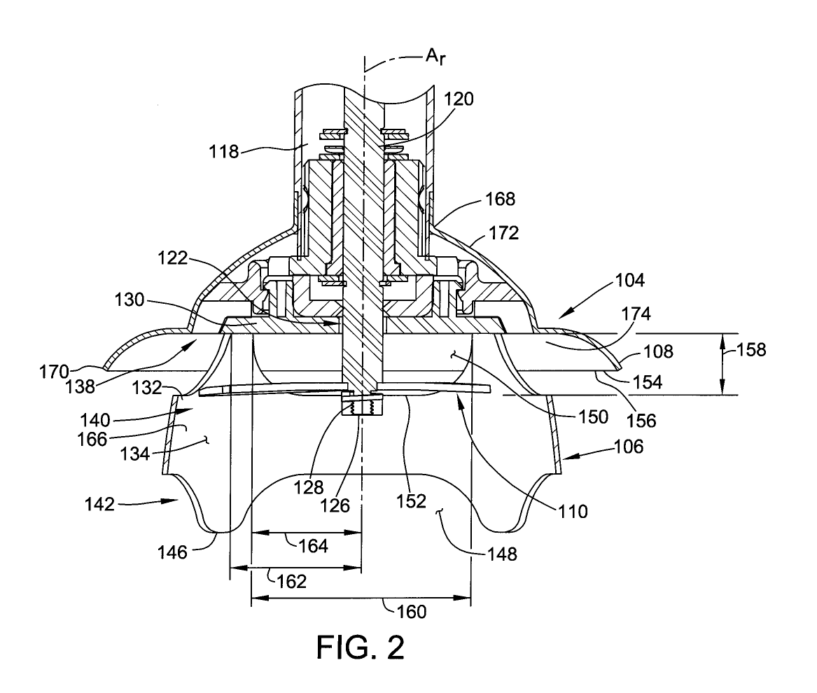

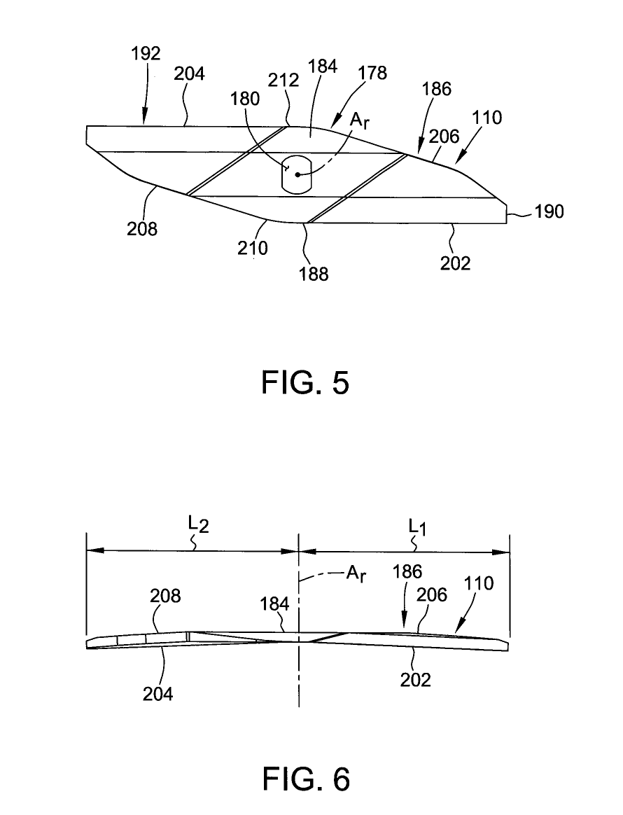

Referring now to the drawings, and more particularly to FIG. 1, one embodiment of a food preparation appliance is indicated generally at 100 and is illustrated in the form of a hand-held blender. The hand-held blender 100 generally includes a handle 102 housing a drive motor (not shown), and a blade assembly 104 connected to and extending longitudinally from the handle 102. The blade assembly 104 generally includes a first or lower (in the illustrated orientation) shroud 106, a second or upper (in the illustrated orientation) shroud 108, and a blade member 110 (seen best in FIGS. 2-6) operatively connected to and driven by the drive motor.

As used herein, direction and/or orientation terms such as lower, upper, bottom and top refer to the upright orientation of the hand-held blender 100 as illustrated in FIG. 1. The term transverse or radial refers to a direction normal to a longitudinal axis X-X running through the longitudinal center of the hand-held blender 100, e.g., horizontal in the illustrated embodiment of FIG. 1. While in the illustrated embodiment the food preparation appliance is in the form of a hand-held blender 100, it is understood that the appliance may be in the form of a food processor or other suitable appliance in which a blade member operates to process food or other materials.

With reference to FIGS. 1-3, the handle 102 includes a grip portion 112, a power switch 114, and a cylindrical sidewall 116 defining a an interior cavity 118 in which the drive motor is housed along with a suitable drive shaft 120 for operatively driving the blade member 110. In alternative embodiments, the sidewall 116 may have any suitable shape that allows the hand-held blender 100 to function as described herein. The handle 102 may be made of a metal, metal alloy, plastic, ceramic, composite or any other suitable materials and combinations thereof that allow the handle 102 to function as described herein. In one suitable embodiment, for example, the handle 102 is constructed of plastic.

The handle 102 is elongate and the grip portion 112 is disposed on the handle 102 a distance from the blade assembly 104. Therefore, a user can grasp the hand-held blender 100 at a location spaced from the food processed by the hand-held blender 100. For example, the user can grasp the grip portion 112 and position the blade assembly 104 in a container at least partly filled with food to be processed. Alternatively, the food to be processed may be sitting on a surface and the user can position the hand-held blender 100 over the surface such that at least a portion of the food is contacted by the blade assembly 104.

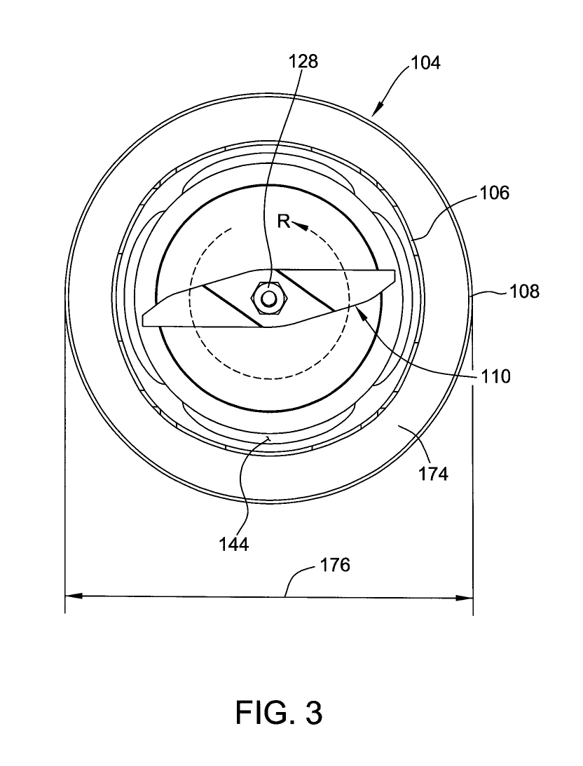

With reference to FIG. 2, the drive shaft 120 extends through an exit opening 122 in the end of handle 102 opposite the grip portion 112 for operative connection to the blade member 110. The blade member 110 is operatively coupled to the drive shaft 120 by a nut 128 that threads onto a threaded end 126 of the drive shaft 120. It is understood that other suitable coupling of the blade member 110 to the drive shaft 120 may be used without departing from the scope of this invention. A sealing gasket 130 seals the exit opening 122 around the drive shaft 120. During operation of the hand-held blender 100, the drive motor (not shown) rotates the drive shaft 120 and, thereby, the blade member 110 in the direction or rotation R indicated by the direction arrow in FIG. 3.

The first or lower shroud 106 has a cup or bell-shaped sidewall 132 having an interior surface defining a blade chamber 134, and an exterior surface. The blade member 110 is thus disposed generally within the blade chamber defined by the first shroud 106. The first shroud 106 includes an upper portion 138, a base portion 142 and an intermediate portion 140 therebetween. The upper portion 138 is coupled to the handle 102 while the base portion 142 defines an open end 144 of the first shroud through which food can enter the blade chamber. The base portion 142 includes feet 146 that at least partly define lower side openings 148 extending circumferentially between the feet 146. These lower side openings 148 facilitate food passing from exterior of the first shroud into the blade chamber 134 during operation of the hand-held blender 100. The feet 146 may be of any suitable shape that permit the shroud to function in its intended manner. In the illustrated embodiment, the first shroud 106 has four feet 146 and corresponding four lower side openings 148. In other embodiments, the first shroud 106 may have any number of feet 146 and/or any number of lower openings 148.

Alternate embodiments of the hand-held blender 100 may exclude the feet 146 and/or the lower side openings 148. For example, the open end 144 and the sidewall 132 may be configured such that hand-held blender 100 draws material in through the open end 144 during operation of the hand-held blender 100, or the blender 100 may be intermittently raised and lowered relative to the food to be processed so that food is surrounded by the first shroud upon lowering the blender into the food. In a further embodiment, the hand-held blender 100 may be configured to turn off, either automatically or manually, when all the material inside the blade chamber 104 has been processed and/or expelled.

The upper portion 138 of the first shroud 106 includes upper side openings 150 defined by respective lower edges 152, upper edges 154, and side edges 156. Each upper side opening 150 has an opening height 158 and an opening width 160 that is suitably greater than the opening height 158. While in the illustrated embodiment the upper openings 150 are rounded slots as seen best in FIG. 1, in other embodiments the upper openings 150 may be circles, rectangles, triangles, and/or any other shapes that allow the hand-held blender 100 to function as described herein.

While in the illustrated embodiment the first shroud 106 includes four upper openings 150, alternative embodiments may have only one upper opening 150 or any number of upper openings 150 that allow the first shroud 106 to function as described herein. While in other embodiments the upper openings 150 may be positioned anywhere, in the illustrated embodiment the upper openings 150 are spaced evenly around the circumference of the first shroud 106 and are aligned with the lower openings 148 to facilitate material cycling through the first shroud 106 as described in more detail below.

Due to the bells-shaped curvature of the first shroud 106, the edges of the upper openings 150 are spaced a varying radial distance from an axis of rotation A_{R} of the blade member 110 (which in the illustrated embodiment coincides with the longitudinal axis X of the hand-held blender 100). Specifically, a first radial distance 162 between the axis of rotation A_{R} and the lower edge 152 of the upper side opening is greater than a second radial distance 164 between the axis of rotation A_{R} and the upper edge 154 of the upper side opening. The different radial spacing of the lower edge 152 and the upper edge 154 facilitates processed food passing from the blade chamber 134 outward of the first shroud via the upper side openings 150. For example, processed food propelled upward by the blade member 110 may pass through the upper side openings 150 of the first or lower shroud without contacting the lower edges 152 because the lower edges 152 are spaced from the axis of rotation A_{R} at a greater radial distance than the respective upper edges 154.

Conversely, the varying radial distance inhibits food from passing through the openings 150 into the blade chamber. Exterior food moving towards the upper side openings 150 from below the first shroud 106 may contact the lower edges 152 and thereby be redirected because the lower edges 152 are the lowest points of the upper openings 150. Exterior food moving toward the upper side openings 150 from above may be redirected by the second or upper shroud 108 as described in more detail below. In addition, the upper side openings 150 are positioned a longitudinal distance from the blade member 110 to inhibit material passing through the upper side openings 150 and contacting the blade member 110. Thus, the shape and position of the upper side openings 150 facilitate material passing from the interior 134 to the exterior 136 and inhibit material passing from the exterior 136 to the interior 134 towards the blade member 110.

The intermediate portion 140 of the first or lower shroud 106 comprises a blade guard portion 166 corresponding generally to the longitudinally position of the blade member 110. The blade guard portion 166 is free from holes or openings and, therefore, inhibits food from directly contacting the blade member 110 from exterior of the first shroud 106. The blade guard portion 166 enhances the safety of the hand-held blender 100 and inhibits damage to the blade member 110. During operation of the hand-held blender, the blade guard portion 166 directs some of the processed food towards the blade member 110 and other food towards the upper side openings 150. In alternate embodiments, the blade guard portion 166 may have small openings therein.

The second or upper shroud 108 is preferably coaxial with the first or lower shroud 106 and comprises a proximal or upper edge 168, a distal or lower edge 170, an upper or handle-facing surface 172 extending generally from the proximal edge 168 to the distal edge 170, and a corresponding lower or processing surface 174 opposite the upper surface 172. While in the illustrated embodiment, the second shroud 108 is shaped as a generally curved or frustoconical plate, in alternate embodiments the second shroud 108 may have any suitable shape.

In the illustrated embodiment the second shroud 108 is formed integral with the handle 102. However, in other embodiments, the second shroud 108 may be formed separate from and suitably held in assembly with the handle 102. In the illustrated embodiment, the second shroud 108 extends transversely or radially outward beyond the first shroud 106 to generally form an “umbrella” over the upper side openings 150 so as to inhibit some of the food that is exterior of the first shroud 106 from flowing through upper side openings 150 into the blade chamber 134. For example, food that is moving towards the upper openings 150 from above the second shroud 108 will strike the upper or handle-facing surface 172 of the second shroud and be redirected away from the upper side openings 150 of the first shroud 106.

The lower or processing surface 174 of the second shroud 108 is substantially concave and, as a result, food that strikes this lower surface 174 will be redirected along the lower surface toward the distal edge 170 in a downward moving direction. Since the distal edge 170 is spaced from the first shroud 106, the food will be redirected away from the upper portion 138 of the first shroud 106. During operation of the hand-held blender 100, the redirection of food by the second shroud 108 reduces the amount of suction generated in the blade chamber 134 and, therefore, allows the hand-held blender 100 to operate more efficiently. The redirection also hinders food being processed from splashing onto the handle 102.

Due to the concave curvature of the lower surface 174 of the second shroud 108, the redirected food material will be directed downward towards the base portion 142 of the first shroud 108 where the food may be drawn by the blade member 110 into the blade chamber 134 via the lower side openings 148. In the illustrated embodiment, the upper side openings 150 are circumferentially aligned with the lower side openings 148 (e.g., one above the other) to facilitate drawing material that has passed outward through the upper side openings 150 and redirected downward by the second shroud 108 back into the blade chamber 134 via the lower side openings 148. Thus, the first shroud 106 and the second shroud 108 facilitate material continually cycling through the blade chamber 134 to increase the efficiency of the hand-held blender 100 and the uniformity of the processed material.

The first shroud 106 and the second shroud 108 may be made of a metal, metal alloy, plastic, ceramic, composite or any other suitable materials and combinations thereof that allow the first shroud 106 and the second shroud 108 to function as described herein. In one suitable embodiment, for example, the first shroud 106 and the second shroud 108 are both constructed of plastic.

The first shroud 106 and the second shroud 108 may be integrally formed or formed separately and coupled together. Additionally, the first shroud 106 and the second shroud 108 may be integrally formed with and/or coupled to the handle 102. In one suitable embodiment, for example, the first shroud 106 and the second shroud 108 are both integrally formed with the handle 102.

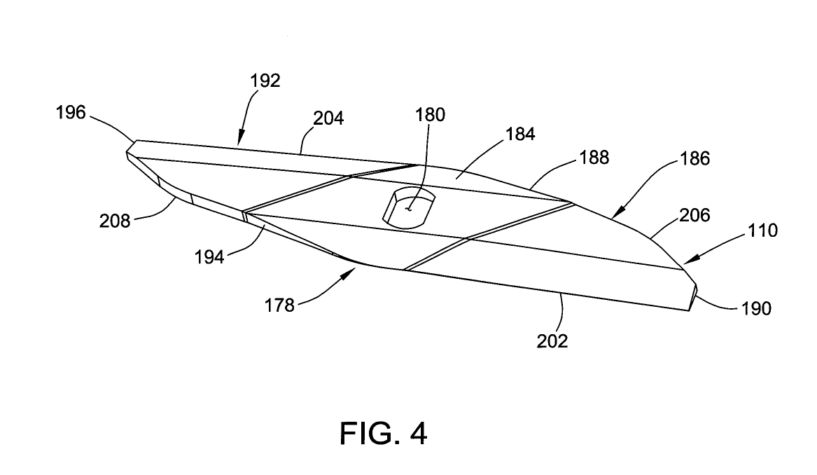

With general reference to FIGS. 4-6, and in particular referring first to FIG. 4, the blade member 110 includes a central hub 178 having an opening 180 therein keyed to the cross-sectional configuration of the lower end of the drive shaft 120 to thereby operatively connect the blade member 110 to the drive motor for driven rotation of the blade member relative to the handle 102 upon operation of the drive motor. In some embodiments, the hub 178 and opening 180 of the blade member 110 may be configured relative to the drive shaft 120 such that the blade member 110 may only be installed in a single orientation (i.e., such that the blade member cannot be installed upside down). The blade member 110 may be releasably or permanently connected to the drive shaft 120 within the scope of this invention. The blade member 110 may be made of a metal, metal alloy, plastic, ceramic, composite or any other suitable materials and combinations thereof that allow the blade member 110 to function as described herein. In one suitable embodiment, for example, the blade member 110 is constructed of stainless steel.

The blade member 110 has a planar portion 184 (including at least part of the hub 178) extending substantially perpendicular to the axis of rotation A_{R} of the blade member. A first wing 186 extends transversely outward from the planar portion 184 and has a proximal end 188 coupled to the planar portion 184 and a distal end 190 outward of the proximal end. A second wing 192 extends transversely outward from the planar portion 184 on a side of the hub 178 opposite the first wing 186. The second wing 192 has a proximal end 194 coupled to the planar portion 184 and a distal end 196 outward of the proximal end 194 of the second wing 192. Each of the first wing 186 and the second wing 192 has a respective leading edge 202, 204 and a respective trailing edge 206, 208. Each of the leading edges 202, 204 has a knife edge (i.e., an angled edge) to facilitate cutting of the material when in use. In the illustrated embodiment, the planar portion 184 has opposite blunt, or squared, outer edges 210, 212, although these edges may be partially or wholly sharpened to a knife edge to improve ease of manufacturing the blade member. For example, the leading edges 202, 204 may be rounded to form a single continuous knife edge that arcs from the leading edges 202, 204 of the wings to the trailing edges 206, 208.

As best illustrated in FIG. 6, the planar portion 184, the first wing 186, and the second wing 192 each extend along a respective different plane such that the blade member 110 has a generally twisted appearance. The planar portion 184 is substantially perpendicular to the axis of rotation A_{R}, which facilitates secure coupling of the blade member 110 to the drive shaft 120. In the illustrated embodiment, the first wing 186 is twisted, such that the leading edge 202 is lower than the trailing edge 206. The second wing 192 is also twisted such that its leading edge 204 is below its trailing edge 208. In one example, each of the first wing 186 and the second wing 192 may be twisted to an angle between about 0.1 degrees to about 15 degrees with respect to the planar portion 184. As such, when the blade member 110 is rotated in the first direction R (FIG. 3), a propeller action is created, which forces materials that are contacted by the blade member in an upward direction toward the first shroud 106 and the second shroud 108. It should be understood that a lower twist angle reduces strain on the drive mechanism, but reduces the propeller action of the blade member 110, while increased twist angles increase the strain on the drive mechanism but also increase the propeller action of the blade member in use. In other embodiments, one or both of the first wing 186 and the second wing 192 may not be twisted and remain within the scope of this invention.

Each of the first wing 186 and the second wing 192 has a radial length L₁, L₂ respectively measured from the axis of rotation A_{R} of the blade member 110 to a center of the respective distal end 190, 196. In the illustrated embodiment, L₁ and L₂ are equal. However, in other embodiments, L₁ and L₂ may be unequal without departing from the scope of this invention. For example, in one embodiment, L₂ is greater than L₁ such that the distance between the second distal end 196 and the first shroud 106 will be less than the distance between the first distal end 190 and the first shroud 106.

It should be noted that when the base portion 142 is pressed against a surface, the hub 178 is sufficiently spaced from the base portion 142 such that the blade member 110 does not make contact with the surface when the hand-held blender 100 is in use. While in the illustrated embodiment the blade member 110 has two wings 186, 192, it is understood that the blade member 110 may have a single wing, or it may have more than two wings, such as four wings, without departing from the scope of this invention. In some suitable embodiments, the blade member 110 may include wingtips extending from the distal ends 190, 196 to further facilitate the blade member 110 contacting chunks in the bottom (heightwise) region of the interior 134, thus minimizing the chances that large chunks will be left under the blade member 110 after processing.

In operation, as the blade member 110 is rotated in the first direction R (FIG. 3), the propeller action of the blade member 110 draws material upward towards the first wing 186 and the second wing 192. The leading edges 202 and 204 then strike the material and break apart the material. The material is then propelled upward and out of the blade chamber at the upper side openings 150. Some of this material will be drawn back into the blade chamber 134 as discussed previously herein by the propeller action of the blade member 110. The material will thus again contact the blade member 110 to be further broken up and propelled upward.

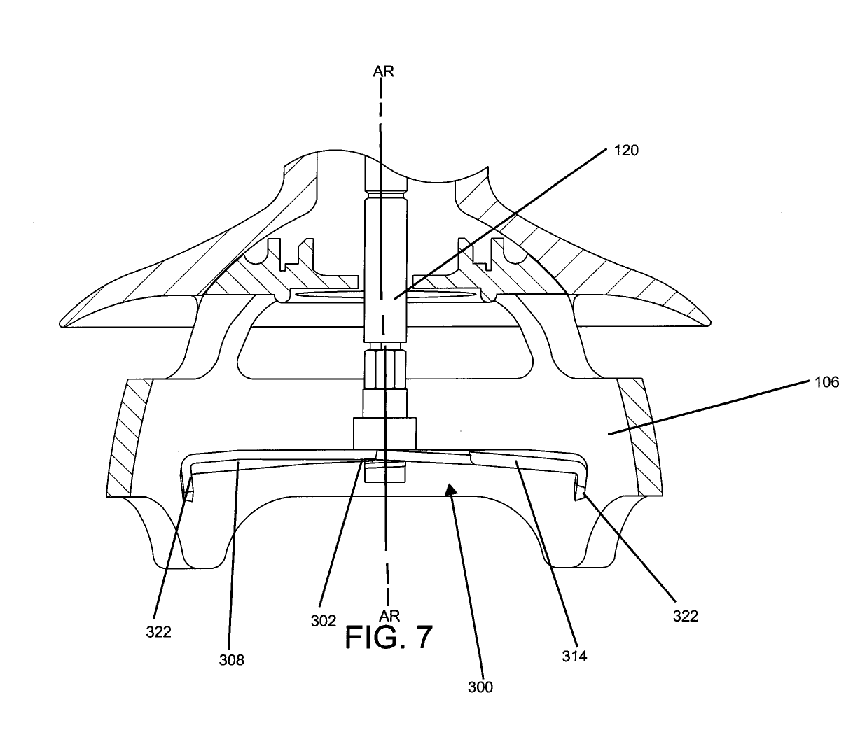

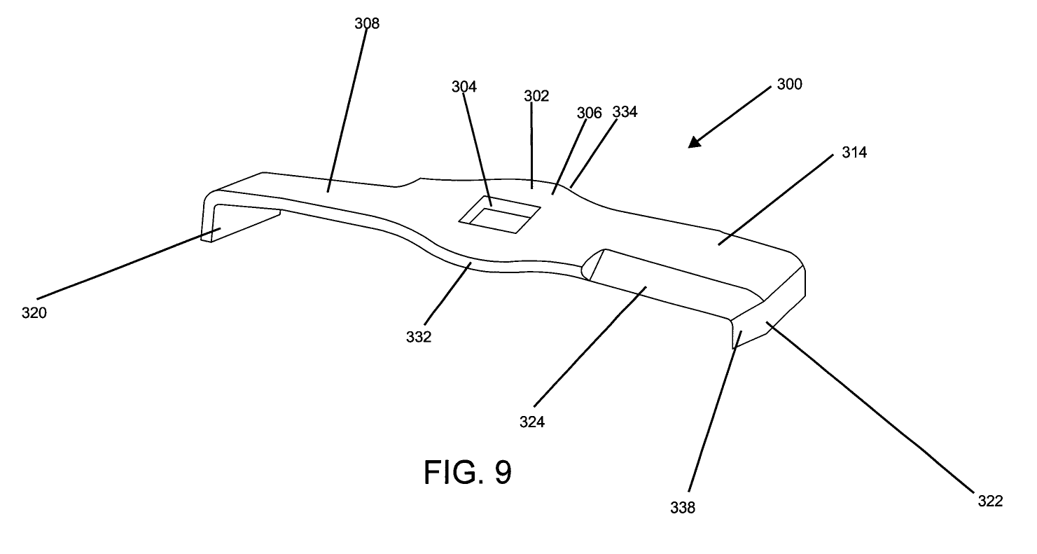

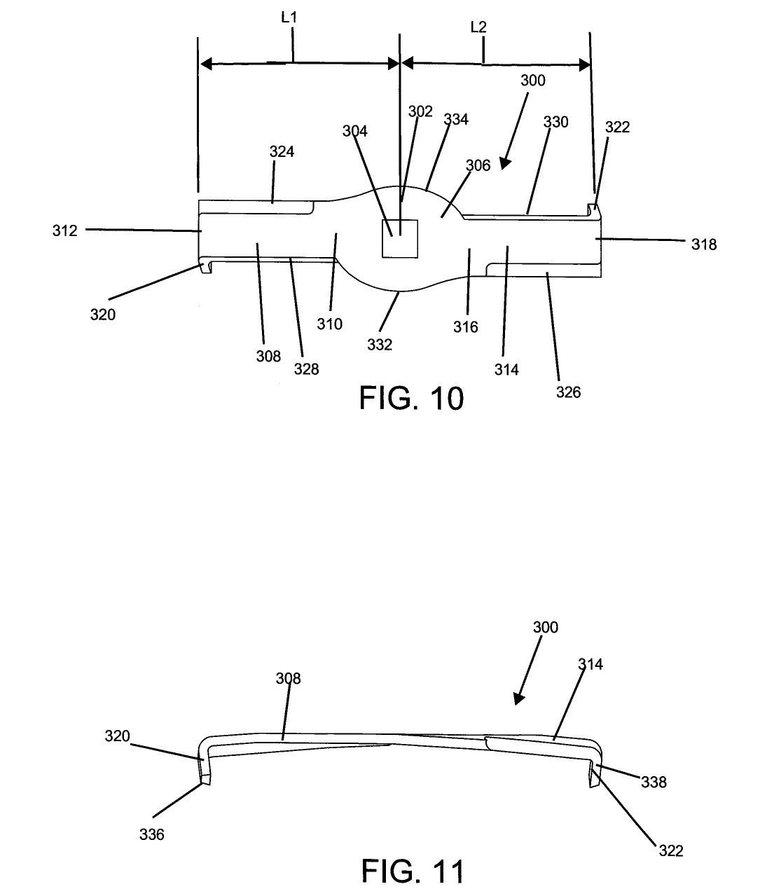

FIGS. 7-11 illustrate an embodiment of a blade member, indicated generally by 300, suitable for use with hand-held blender 100. The blade member 300 includes a central hub 302 having an opening 304 therein keyed to the cross-sectional configuration of the lower end of the drive shaft 120 to thereby operatively connect the blade member 300 to the drive motor for driven rotation of the blade member relative to the handle 102 upon operation of the drive motor. The blade member 300 has a planar portion 306 (including at least part of the hub 302) extending substantially perpendicular to the axis of rotation A_{R} of the blade member.

A first wing 308 extends transversely outward from the planar portion 306 and has a proximal end 310 coupled to the planar portion 306 and a distal end 312 outward of the proximal end 310. A second wing 314 extends transversely outward from the planar portion 306 on a side of the hub 302 opposite the first wing 308. The second wing 314 has a proximal end 316 coupled to the planar portion 306 and a distal end 318 outward of the proximal end 316 of the second wing 314. A downturned first wingtip 320 extends downward from the distal end 312 of the first wing 308 and a downturned second wingtip 322 extends downward from the distal end 318 of the second wing 314. The first wingtip 320 and the second wingtip 322, according to one embodiment, are bent at a bend radius of between about 1 millimeter to about 5 millimeters. Each of the first wing 308 and the second wing 314 has a respective leading edge 324, 326 and a respective trailing edge 328, 330. Each of the leading edges 324, 326 has a knife edge (i.e., an angled edge) to facilitate cutting of the material when in use. In the illustrated embodiment, the planar portion 306 has opposite blunt, or squared, outer edges 332, 334, although these edges may be partially or wholly sharpened to a knife edge to improve ease of manufacturing the blade member.

Similarly, respective leading edges 336, 338 of the first wingtip 320 and the second wingtip 322 have angled knife edges to further facilitate cutting or chopping of material. As seen best in FIG. 11, the wingtips 320, 322 are generally rectangular in shape (e.g., in profile as viewed from the longitudinal ends). In other embodiments, however, one or both of the wingtips 320, 322 may be other than rectangular in profile and remain within the scope of this invention. For example, the leading edge 324, 326 of either one or both of the wingtips 320, 322 may be curved, e.g., rounded. The upper edges of the wingtips 320, 322 may also be rounded such that the leading edges 324, 326, 336, 336, and upper edges together form a single continuous knife edge that arcs from the leading edges 324, 326 of the wings 308, 314 to the trailing edges 328, 330.

Each of the first wing 308 and the second wing 314 has a radial length L₁, L₂ respectively measured from the axis of rotation A_{R} of the blade member 300 to a center of the respective wingtip 320, 322. In the illustrated embodiment, L₁ and L₂ are equal. However, in other embodiments, L₁ and L₂ may be unequal without departing from the scope of this invention. For example, in one embodiment, L₂ is greater than L₁ such that the distance between the second wingtip 322 and the first shroud 106 will be less than the distance between the first wingtip 320 and the first shroud 106.

Referring to FIG. 11, the first wingtip 320 is bent downward from the first wing 308 at an angle that is between 70 degrees and 110 degrees relative to the planar portion 306 of the blade member 300. The second wingtip 322 is also bent downward with respect to the second wing 314 at a downward angle that is between 70 degrees and 110 degrees relative to the planar portion 306. However, the first wingtip 320 and second wingtip 322 may be bent at any angle that allows the blade member 300 to function as described herein. Additionally, each of the first wingtip 320 and the second wingtip 322 may be angled relative to the generally straight leading edges 336, 338 to further facilitate the leading edge 336 of the downturned first wingtip 320 and the leading edge 338 of the downturned second wingtip 322 contacting chunks in the bottom (heightwise) region of the interior 134, thus minimizing the chances that large chunks will be left under the blade member 300 after processing. The hub 302 is sufficiently spaced from the base portion 142 such that the first wingtip 320 and second wingtip 322 do not make contact with the surface when the base portion 142 is pressed against a surface and the blender 100 is in use.

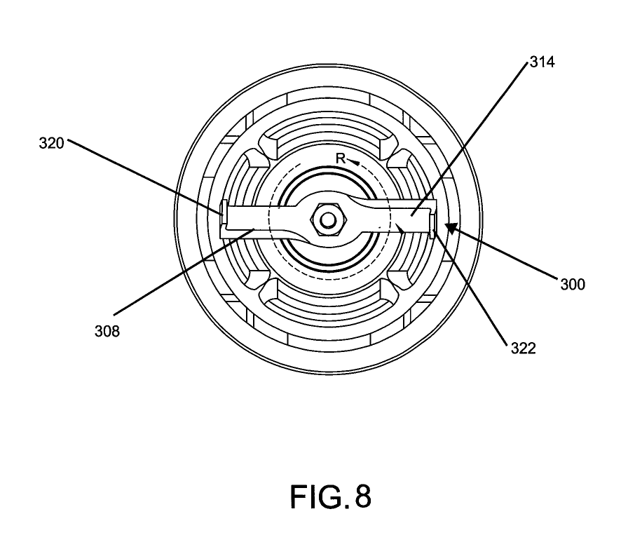

In operation, as the blade member 300 is rotated in the first direction R (FIG. 8), the first wingtip 320 and second wingtip 322 may contact and break-apart large chunks of material in the blade chamber 134 of first shroud 106 before the material is drawn upwardly toward the first wing 308 and the second wing 314 by the propeller action of the blade member 300. The leading edges 324 and 326 then strike the material and further break apart the material. The material is then propelled upward and out of the blade chamber at the upper side openings 150. Some of this material will be drawn back into the blade chamber 134 as discussed previously herein by the propeller action of the blade member 300. The material will thus again contact the blade member 300 to be further broken up and propelled upward.

Operation of the hand-held blender 100 will now be described. The blade assembly 104 is connected to the handle 102 as illustrated in FIG. 1. The drive coupling operatively connects to the drive motor (not shown) housed in the handle 102 of the hand-held blender 100 such that the drive motor imparts a rotation to the drive coupling, and thus the blade member 110, upon operation of the drive motor. A user positions the hand-held blender 100 to process one or more materials (e.g., food or other contents to be processed). The material can be contained within a container (not shown) or supported by a surface (not shown). The hand-held blender 100 is positioned such that at least a portion of the material is within the blade chamber 134 of the first shroud 106. The base portion 142 may be pressed against a surface such that at least a portion of the material on the surface is placed within the interior 134 of the first shroud 106 adjacent the blade member 110. The hand-held blender 100 is then activated (e.g., by switch 114 illustrated in FIG. 1) to operate the drive motor—thereby rotating the blade member 110 relative to the first shroud 106.

As the blade member 110 rotates, the blade member contacts the material in the first shroud 106, as discussed above. That is, the material is propelled upward and struck by the leading edges 202, 204. In suitable embodiments, the first wingtip 320 and second wingtip 322 may contact the material to facilitate to direct it upward towards leading edges 202, 204. Due to the rotation of the blade member 110, the contents in the first shroud 106 move in an upward direction as well as circularly in the direction of rotation R (FIG. 3) of the blade member. As such, a “vortex” may be generated in the contents below the blade member 110 pulling material surrounding blade assembly 104 into the blade chamber 134 through lower side openings 148. Thereupon, the propeller action of the blade member 110 continues to propel the contents upward toward and through the upper side openings 150. Once the material passes through the upper side openings 150, the material strikes the second shroud 108. The second shroud 108 directs the material downward and outward relative to the first shroud 106. The second shroud 108 thus helps to redirect the contents back down towards the base portion 142 of the first shroud to fill in voids created by the generated vortex. The redirected material may then be drawn back into the blade chamber 134 at the lower side openings 148 to help prevent cavitation in the contents around the blade member 110.

Therefore, the configuration of the hand-held blender 100 including the two shrouds 106, 108 inhibits stagnant flow and ensures material is efficiently processed by the blade member 110. The blade member 110 propels the material upward and through upper side openings 150 in first shroud 106. The second shroud 108 directs the material back downward toward the blade member 110 wherein the flow path of the contents is generally repeated until the hand-held blender 100 is turned off. The second shroud 108 inhibits objects contacting the blade member 110 and reduces the amount of splashing during operation. As a result, the two shrouds 106, 108 and blade member 110 increase the efficiency, performance, usability, and safety of the hand-held blender 100.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A food preparation appliance, comprising:
a handle;
a blade operable to rotate on a rotation axis;
a first shroud coaxial with the blade and defining a blade chamber, the blade being disposed generally within the blade chamber, the first shroud having an upper side opening through which food can exit the blade chamber; and
a second shroud coaxial with the first shroud and located exterior of the blade chamber, the second shroud being positioned and configured relative to the first shroud for redirecting food that exits the blade chamber through the upper side opening.

2. The food preparation appliance set forth in claim 1, wherein the first shroud comprises an upper portion, a base portion and an intermediate portion defining a blade guard, the base portion being open.

3. The food preparation appliance set forth in claim 1, wherein the second shroud has an upper surface facing the handle and a lower surface opposite the upper surface, at least a portion of the lower surface being concave such that food exiting the blade chamber of the first shroud at the upper side opening is redirected generally downward toward the base portion of the first shroud upon contacting the lower surface of the second shroud.

4. The food preparation appliance set forth in claim 1, wherein the second shroud comprises a plate extending at least in part radially outward from the handle.

5. The food preparation appliance set forth in claim 4, wherein the second shroud extends radially outward beyond the first shroud such to inhibit objects disposed above the second shroud from entering the blade chamber at the upper side opening of the first shroud.

6. The food preparation appliance set forth in claim 5, wherein the second shroud further comprises a distal edge spaced from the first shroud.

7. The food preparation appliance set forth in claim 1, wherein the first shroud has a plurality of upper side openings spaced circumferentially from each other about the first shroud.

8. The food preparation appliance set forth in claim 1, wherein the base portion of the first shroud at least in part has a lower side opening through which food enters the blade chamber from exterior of the blade chamber, the lower side opening being longitudinally aligned with the upper side opening.

9. A method for processing food using a food preparation appliance, the appliance having a handle, a first shroud disposed generally at one end of the handle and defining a blade chamber, a second shroud coaxial with the first shroud and longitudinally nearer to the handle than the first shroud, and a blade member coaxial with the first shroud and disposed generally within the blade chamber, the method comprising:
positioning the food preparation appliance such that at least some food is disposed within the blade chamber;
rotating the blade member to contact the food to thereby process the food;
directing processed food out of the blade chamber through an upper side opening in the first shroud for impact with the second shroud exterior of the blade chamber; and
further directing the processed food from the second shroud back toward the blade chamber other than at the upper side opening of the first shroud.

10. The method set forth in claim 9, wherein the blade member comprises a planar portion, a first wing, and a second wing, and wherein at least one of the first wing and the second wing includes an angled surface such that the blade member propels material that contacts the blade member upward as it rotates.

11. The method set forth in claim 9, wherein the second shroud comprises a curved plate extending radially outward from the handle to a distal edge spaced from the first shroud.

12. The method set forth in claim 9, wherein directing the food through an upper side opening in the first shroud comprises directing the food through a plurality of upper side openings in the first shroud.

13. The method set forth in claim 9, further comprising directing the food along a processing surface of the second shroud, the processing surface being at least in part concave curve to redirect the food downward back toward the first shroud.

14. The method set forth in claim 9, further comprising positioning a base portion of the first shroud down against a surface, the base portion having a lower side opening through which food to be processed can the blade chamber, the method further comprising drawing food into the blade chamber at the lower side opening.

15. A blade member for a food preparation appliance, the appliance having a drive motor for operative connection with the blade member to drive rotation of the blade member about an axis of rotation of the blade member, the blade member being elongate and having a length, the blade member comprising:
a central planar portion extending substantially perpendicular to the axis of rotation of the blade member to lie in a first plane, the central planar portion having a first lengthwise end and a second lengthwise end opposite the first lengthwise end with the rotation axis of the blade member disposed therebetween;
a first wing having a proximal end coupled to the first end of the central planar portion and a distal end disposed lengthwise outward of the proximal end of the first wing;
a second wing having a proximal end coupled to the second lengthwise end of the central planar portion and a distal end disposed lengthwise outward of the proximal end of the second wing; and
at least a portion of the first wing lying in a second plane different from the first plane of the central planar portion.

16. The blade member set forth in claim 15, wherein the second plane is at an angle in the range of about 0.1 degrees to about 20 degrees relative to the first plane.

17. The blade member set forth in claim 15, wherein at least a portion of the second wing lies in a third plane different from the first plane, the third plane lying at an angle in the range of about −0.1 degrees to about −20 degrees in relation to the first plane.

18. The blade member set forth in claim 15, wherein the first wing has a first length measured from the proximal end of the first wing to the distal end thereof and the second wing has a second length measured from the proximal end of the second wing to the distal end thereof, the second length of the second wing being different from the first length of the first wing.

19. The blade member set forth in claim 15, wherein the blade member has a direction of rotation about the rotation axis of the blade member, the first wing having a leading edge in the direction of the rotation of the blade member, the second wing having a leading edge in the direction of rotation of the blade member, the leading edges of the first and second wings each having a respective angled cutting surface.

20. The blade member set forth in claim 15, wherein the blade member has a direction of rotation about the rotation axis of the blade member, the first wing and the second wing each imparting an axial upward flow of contents impacted by the blade member upon rotation of the blade member in the direction of rotation.
